(19) United States
(12) Patent Application Publication
(10) Pub. No.: US 2006/0289009 A1
(43) Pub. Date: Dec. 28, 2006

(54) Coordinated medical face mask system

(76) Inventors: Joe Palomo, Antioch, IL (US); Kevin Brunson, Aledo, TX (US); Darrell Caldwell, Glenrose, TX (US); Fred Whitaker, Alexander, NC (US); Diane Holcombe, Fletcher, NC (US); Doug Katz, Mt Arlington, NJ (US); Andrew G. Rozycki, Columbus, OH (US)

Correspondence Address: Kimberly Luna;Allegiance Corporation, 1430 Waukegan Road, McGaw Park, IL, 60085, US

(21) Appl. No.: 11/166,701

(22) Filed: Jun. 24, 2005

(51) Int. Cl. A62B 23/02

(52) U.S. Cl. 128/206.19

(57) ABSTRACT

The invention herein provide a medical face mask system that does not interfere with the performance of the masks and yet provides a continuous visually comforting image for the child patient. The medical face mask system includes coordinating a related design to be present on the adult or practitioner's face mask as well so that the child can continue to view the comforting image throughout the duration of a procedure, treatment, or examination. The invention provides a coordinated medical face mask system comprising: at least adult one face mask sized for an adult wearer; and at least one child face mask sized for a child wearer and having dimensions smaller than said adult face mask; wherein each of said adult face mask and child face mask comprise an externally viewable design that corresponds to the design present on the other mask.

### FIELD OF THE INVENTION

The invention relates to the field of medical devices. In particular, the invention pertains to face masks used in preparation for and/or during medical procedures, such as surgery.

### BACKGROUND OF THE INVENTION

Medical face masks and respirators are well known. Also known are colored face masks and face masks having exterior viewable patterns thereon. Colors and patterns on medical garments and accessories have been used to identify attributes or to indicate intended usage environments, or to otherwise provide a more pleasant appearance than the ordinary or bland white fabric.

A variety of techniques have been utilized in the hospital or clinical environment to accommodate the special needs of children. Such techniques have included a number of environmental techniques or methods to reduce fear, create familiarity and comfort when subjecting a child or infant to the medical environment, such as introducing toys, utilizing cartoon or storybook characters, maintaining the visual presence of parents throughout a procedure, and the like. The creation and maintenance of a comfortable, non-intimidating psychological environment is especially important and beneficial in children's hospitals or treatment centers.

One area of difficulty encountered in the medical profession is disguising or adapting medical instruments to appear less intimidating without interfering with their function or performance requirements. Utilizing child-oriented characters or patterns on medical garments and face masks is known. Once these printed garments and accessories are placed on the child patient, however, they become less visible to the child patient. In the case of medical face masks, a pleasing or comforting pattern can be present on the exterior surfaces of such masks. Once the mask is placed over the child's face, however, the pleasing or comforting image is no longer viewable to the child. Thus, the desired comforting effect is attenuated or lost altogether.

There is a need in the medical field for improved visually comforting devices and equipment for children and youngsters that are continuous in comforting effect, yet do not compromise the functional and performance requirements of such devices or equipment.

### SUMMARY OF THE INVENTION

The invention provides a medical face mask system that does not interfere with the performance of the masks and yet provides a continuous visually comforting image for the child patient. It has been discovered that pleasing or comforting images can continue to be enjoyed by the child patient by not only applying an image or design onto the child's mask, but coordinating a related design to be present on the adult or practitioner's face mask as well so that the child can continue to view the comforting image.

In particular, the invention provides a coordinated medical face mask system comprising: at least adult one face mask sized for an adult wearer; and at least one child face mask sized for a child wearer and having dimensions smaller than said adult face mask; wherein each of said adult face mask and child face mask comprise an externally viewable design that corresponds to the design present on the other mask.

The invention also provides a method of preparing for a medical procedure for a child comprising: providing an adult face mask sized for an adult wearer; providing a child face mask sized for a child wearer; wherein each of said masks comprises an eternally viewable design that corresponds to the design present on the other mask; performing said medical procedure while said masks are worn by both said adult wearer and child wearer.

The invention is particularly useful in medical environments that typically intimidate or frighten a child patient but where reducing fear and enhancing psychological comfort in children is desired, such as children's hospitals.

### BRIEF DESCRIPTION OF THE DRAWINGS

The invention is further illustrated by the following drawings, none of which is to be construed as necessarily limiting the invention.

FIG. 1 is a view of an adult and child wearing the face mask system according to one embodiment of the invention.

FIGS. 2A and 2B together are a pair of different size face masks (2A being the adult size and 2B being the smaller size) of the face mask system comprising externally viewable designs according to one embodiment of the invention.

FIGS. 3A and 3B together are a pair of different size face masks (3A being the adult size and 3B being the smaller size) of the face mask system comprising externally viewable designs according to one embodiment of the invention.

FIGS. 4A and 4B together are a pair of different size face masks (4A being the adult size and 4B being the smaller size) of the face mask system comprising externally viewable designs according to one embodiment of the invention.

FIGS. 5A and 5B together are a pair of different size face masks (5A being the adult size and 5B being the smaller size) of the face mask system comprising externally viewable designs according to one embodiment of the invention.

FIGS. 6A and 6B together are a pair of different size face masks (6A being the adult size and 6B being the smaller size) of the face mask system comprising externally viewable designs according to one embodiment of the invention.

FIGS. 7A and 7B together are a pair of different size face masks (7A being the adult size and 7B being the smaller size) of the face mask system comprising externally viewable designs according to one embodiment of the invention.

### DETAILED DESCRIPTION OF THE INVENTION

In general, the invention comprises a coordinated face mask system at least adult one face mask sized for an adult wearer; and at least one child face mask sized for a child wearer and having dimensions smaller than said adult face mask; wherein each of said adult face mask and child face mask comprise an externally viewable design that corresponds to the design present on the other mask.

A wide variety of medical masks can be used in accordance with the invention. The mask construction and structure can be identical or different from at least one other mask in the system, provided the dimensions of at least one mask differ from those of another. For example, a practitioner mask and child mask can have the same construction and be composed of the same materials and filtration properties, provided the externally viewable designs coordinate with one another per the invention.

One of the advantages of the invention is that the features associated with the comforting visual effect does not interfere or compromise the structural features, requirements or properties desired in medical face masks. As far as mask structure is concerned, the masks used in the system of the invention can include: structural features such as an upper malleable nose strip, attachment structures such as ear loops, ties, and headbands.

Various mask configurations and structural features can be employed in the invention. As far as overall configuration, masks prepared in accordance with the invention can be flat, pleated, duckbill-type, molded cone, respirator and vertical front seam mask structures. Various attachment structures can be used in accordance with the invention, including but not limited to, surgical ties, ear loops, elastic headbands, adhesives, and the like. Secondary mask structures can be employed with the invention as well, such as eye protection features. Suitable eye protection features include, but are not limited to: attached eye shields; separate eye shields with matching patterns on the frame; eye shields that attach onto the mask having eyes, goggles or glasses; and separate eye shields having eyes, goggles or glasses.

Medical face masks can be constructed with various materials, overall layer arrangements and performance criteria suitable for their intended use. Suitable layer arrangements include those having an overall construction comprising a layer arrangement of an inner facing panel, filter media, and outer facing panel, wherein the filter media is located between the inner and outer panels. Each of the inner facing panel and outer facing panel can be composed of various materials known and readily available in the field of medical masks. Examples of suitable inner facing panel and outer facing panel materials that can be used include woven and non-woven fabrics. Suitable nonwoven materials include single or multilayer meltspun polyolefin nonwoven materials (SB, SSS, SS, SMS, and the like), rayon, cellulose, polyester, nylon. Cellulose, polyester, spunbond polyolefin (polypropylene, polyethylene, or combinations thereof), SMS polyolefin (polypropylene, polyethylene, or combinations thereof), Delnet™, and the like, can also be used. Suitable filtration media that can be used includes, but is not limited to, meltblown filter media composed of polyolefin, nylon, and polyester.

In one embodiment, the masks used in the mask system of the invention can have the following performance characteristics:
bacterial filtration efficiency (BFE)=5-99.9%
particulate filtration efficiency (0.1 and 1 micron)=5-99.9%
delta P=0.5-5.5 mm water
air permeability=40-400 cfm/sqft
synthetic blood strikethrough a. failure at all levels b. pass @ 80 mmHg c. pass @ 120 mmHg d. pass @ 160 mmHg.

It will be understood that although the invention requires at least one adult size mask and at least one child size mask, the invention can comprise multiple adult size masks coordinated with a single child mask. This situation can occur in procedures where both one or more doctors, nurses, or both, are simultaneously present with the child patient. Thus, this embodiment of the invention affords the ability of a larger number of adult practitioners or staff to participate in the child patient's environment.

The corresponding externally viewable designs on the adult mask and the child mask can be similar or different from one another. A wide variety of corresponding design pairings can be used with the invention.

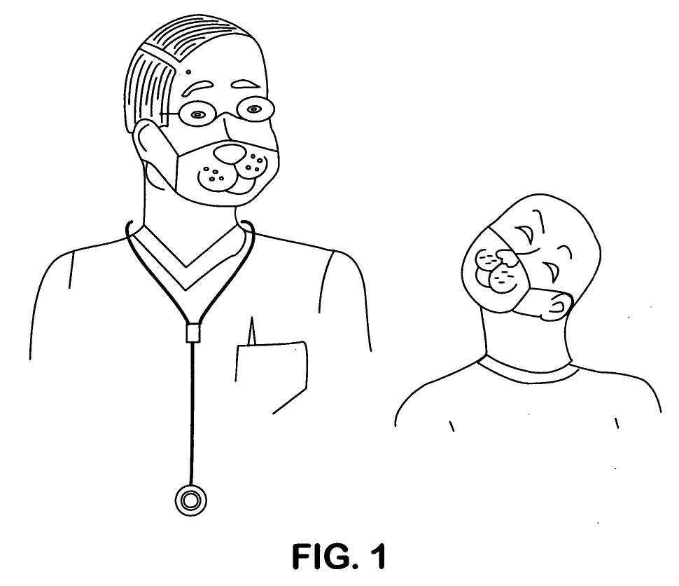

The term “externally viewable designs” that correspond to one another within the context of the invention is meant to describe logically or thematically-compatible pairings of design objects, phrases, symbols, and the like, directed toward a child's perception, familiarity, understanding, and/or recognition levels. Preferably, the designs induce a psychological sensation of comfort from the child's standpoint. Turning now to the figures, FIG. 1 shows an adult and child each wearing coordinated masks according to the invention.

The externally viewable design can be applied or incorporated into the outermost facing mask material(s) using a variety of conventional equipment and techniques readily available to those skilled in the medical fabric field. The applied designs can be single color or monochromatic, or alternatively multiple color designs.

Examples of externally viewable design pairings according to the invention include thematically-related matching characters and objects with one located on the adult size mask and the other located on the child size mask, such as: cowboy and horse; the words “doctor” and “patient”; bird and nest; dog and bone; kitten and yarn ball; mouse and cheese; flower and bee; goldfish and goldfish bowl; astronaut and rocket or moon; and the like. Other design pairings that can be used include recognizable adult-infant relationships, such as: elephant and baby elephant; chicken and baby chick; cat and kitten; dog and puppy; and the like. Design pairings contemplated by the invention can also include matching humorous images on each mask of a pair, such as: cartoon clown nose/mouth; cartoon noses/smiles; cartoon animal nose/mouth; and the like. Otherwise, matching identical colors, patterns, prints, designs, figures, and the like can also be used.

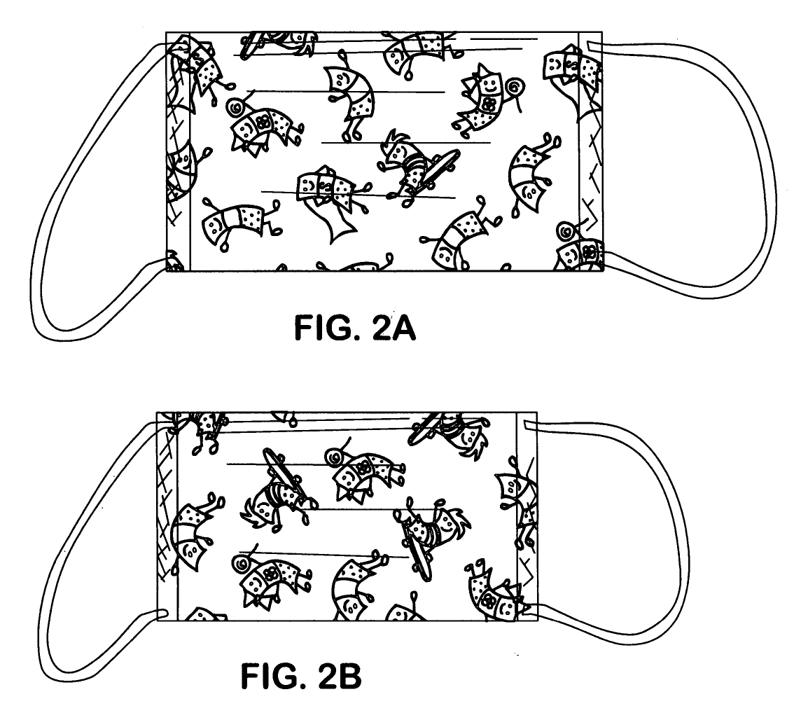

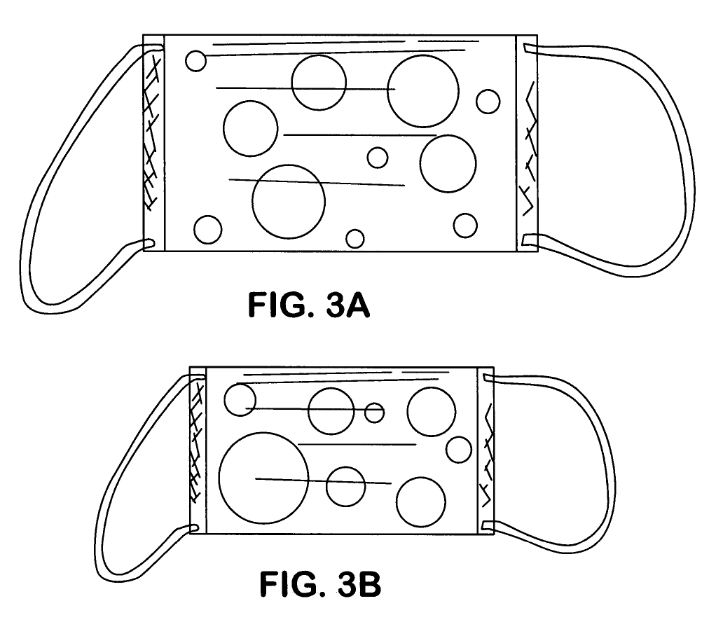

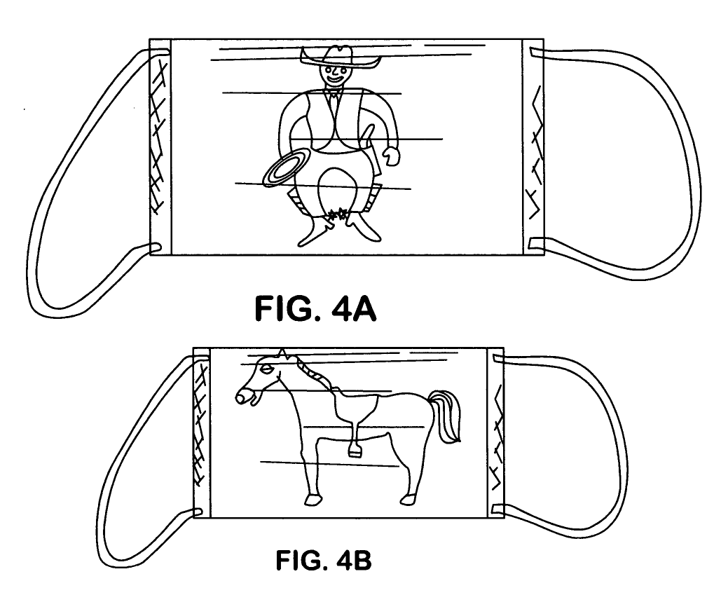

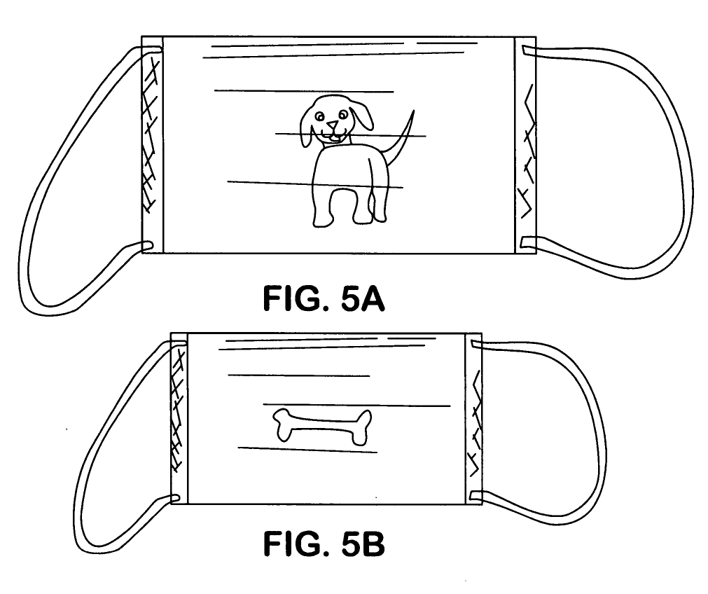

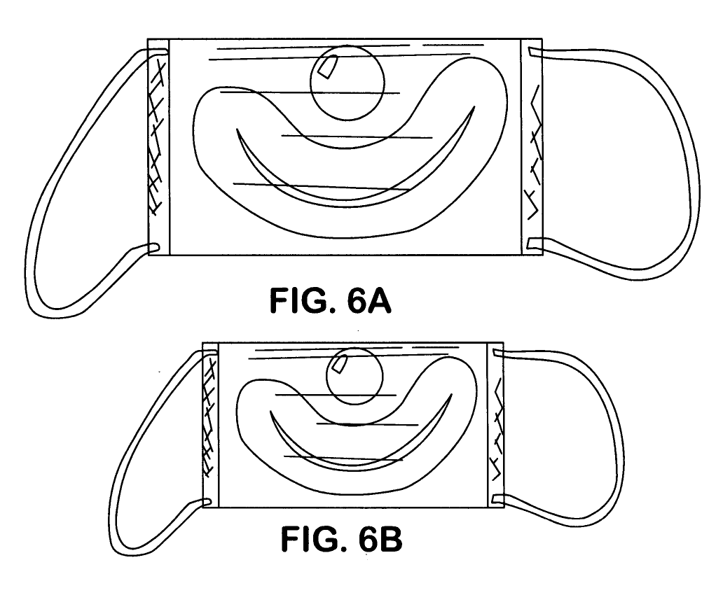

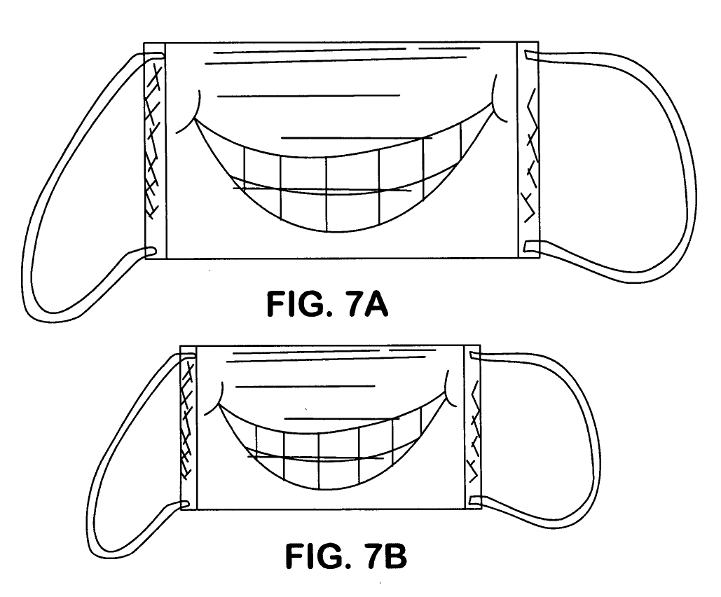

Various coordinated mask and externally viewable designs are illustrated in FIGS. 2 through 7. FIGS. 2A and 2B and FIGS. 3A and 3B illustrate a pair of masks according to the invention containing a repeating pattern or design as the externally viewable design. FIGS. 4A and 4B and 5A and 5B illustrate masks systems wherein the larger size mask contains an externally viewable design that is different but thematically related to the corresponding smaller size mask. FIGS. 6A and 6B and 7A and 7B illustrate pairs of masks using humorous images o each of the different sized masks in the system.

The masks used in the system of the invention can be made in accordance with conventional equipment and techniques readily available in the face mask manufacturing field. For example, inner facing panel, outer facing panel and filtration media can be die cut and assembled and seamed together using adhesive, thermal, RF or ultrasonic welding techniques. Other components or structures, such as malleable strips and ear loops or ties, for example, can be incorporated into the masks using conventional techniques. In one embodiment, the face masks can be prepared by winding the outer facing material, filter media and inner facing material together on a roll and running the three layers over formers to pleat the masks. Nose wire can be laid in place, followed by binding the edges and then attaching ties by ultrasonic sealing.

A number of packaging systems and options can be used with the invention. For example, a group of adult sized masks and a group of corresponding child masks can be packaged separately and within the same unit. Alternatively, adult masks and child masks can be packaged and presented in two-mask paired units.

The invention also provides a method of preparing for a medical procedure for a child comprising: providing an adult face mask sized for an adult wearer; providing a child face mask sized for a child wearer; wherein each of said masks comprises an externally viewable design that corresponds to the design present on the other mask; performing said medical procedure while said masks are worn by both said adult wearer and child wearer. The mask system can be employed in a wide variety of medical situations and procedures where masks would typically be worn by both an adult and child patient at the same time. For example, the mask system can be used in emergency environments, or during medical testing or diagnostic procedures, rehabilitation and recovery, and the like. The optimal benefits associated with the invention are realized in medical environments that typically frighten or intimidate a child patient.

### INDUSTRIAL APPLICABILITY

The coordinated medical face mask system of the invention can be used in a variety of medical or clinical settings where an adult, e.g., medical practitioner, and a child, e.g., child patient, would both wear face masks as part of a medical procedure. The invention is particularly useful in a children's hospital environment where enhancing the comfort and reducing juvenile fear is desirable.

The invention has been described herein above with reference to various and specific embodiments and techniques. It will be recognized by one of ordinary skill that reasonable modifications and adjustments can be made to such embodiments and techniques without substantial departure from the spirit and scope of the invention defined by the claims below.

1. A coordinated medical face mask system comprising:
at least one adult face mask sized for an adult wearer; and
at least one child face mask sized for a child wearer and having dimensions smaller than said adult face mask;
wherein each of said adult face mask and child face mask comprise an externally viewable design that corresponds to the design present on the other mask.

2. A method of preparing for a medical procedure for a child comprising:
providing an adult face mask sized for an adult wearer;
providing a child face mask sized for a child wearer;
wherein each of said masks comprises an externally viewable design that corresponds to the design present on the other mask;
performing said medical procedure while said masks are worn by both said adult wearer and child wearer.

3. A method of interacting with a child patient comprising:
providing an adult face mask sized for an adult wearer;
providing a child face mask sized for a child wearer;
wherein each of said masks comprises an externally viewable design that corresponds to the design present on the other mask.

4. A coordinated medical face mask system as set forth in claim 1 wherein both of said masks are stored in a common unit so that an adult face mask and a child face mask may be readily withdrawn from the unit for coordinated use by an adult and a child.

5. A method for preparing for a medical procedure for a child as set forth in claim 2 further including storing both of said face masks in a common unit; withdrawing an adult face mask and a child face mask from said common unit; applying said adult face mask to an adult and applying said child face mask to a child.

6. A method of interacting with a child patient as set forth in claim 3 further including storing both of said face masks in a common unit; withdrawing an adult face mask and a child face mask from said common unit; applying said adult face mask to an adult and applying said child face mask to a child.
